(19) United States
(12) Patent Application Publication
(10) Pub. No.: US 2022/0388273 A1
(43) Pub. Date: Dec. 8, 2022

(54) SELF-REINFORCED POLYMER STRUCTURES

(71) Applicant: Graham WILLIAMS, Portland, OR (US)

(72) Inventor: Graham WILLIAMS, Portland, OR (US)

(21) Appl. No.: 17/831,095

(22) Filed: Jun. 2, 2022

Related U.S. Application Data
(60) Provisional application No. 63/196,833, filed on Jun. 4, 2021.

(51) Int. Cl. B32B 5/26; B32B 5/02; B32B 7/12

(52) U.S. Cl. CPC B32B 5/263; B32B 5/024; B32B 7/12; B32B 2262/0261; B32B 2262/0253

(57) ABSTRACT

A self-reinforced polymer adhered to a textile.

### CROSS-REFERENCE TO RELATED APPLICATIONS

This application claims the benefit of U.S. Provisional Patent Application No. 63/196,833 filed Jun. 4, 2021.

### BACKGROUND OF THE INVENTION

As industries such as aerospace, automotive, construction, and military containers, there is increased demand for lighter and lighter polymer composites and particularly thermoplastic composites. This trend is due to the composites offering high performance materials with minimal weight in comparison with metal material, such as high strength steels.

Moreover, the thermoplastic materials are suitable for being re-melted and re-molded into new components which is not possible with the inclusion of fibers such as glass or carbon, as such materials cannot be melted down. Also, the thermoplastic materials are suitable to be shredded and used for lower performance reinforced polymer composites.

Self-reinforced polymer composites (e.g., self-reinforced plastics and single polymer composites), are fiber reinforced composite materials. The fiber reinforcement in the materials is highly oriented version of the same polymer from which the matrix is made.

Self-reinforced polymer composites are manufactured from a variety of different thermoplastic polymers such as polyamide, polyethylene, polyethylene terephthalate, ultra-high density polyethylene, ultra-high density polypropylene, and polypropylene.

Stiffness is a property which is augmented as a result of turning a material into a self-reinforced polymer composite. Strength, heat deflection temperature, and impact performance are all increased while offering little increase in the density of the material. The increase in impact performance is due to interfacial failure between the polymer tapes/fibers and the matrix material around them. This is a failure mechanism which does not exist in virgin unreinforced polymers as obviously there are no tapes/fibers and no interfacial bonds, and thus the materials react as they traditionally would. As with all fiber reinforced composites, these materials gain their properties by transferring loads from the relatively low property matrix material into the high performance reinforcement fibers. Due to the very high level of molecular orientation within the reinforcements of self-reinforced polymer composites resulting from high draw ratios (up to 20 or more for polypropylene), the tape/fiber reinforcement within these materials has vastly higher properties than the unmodified material. Due to this, more traditional failure mechanisms such as tensile failure are delayed due to the transmission of load from the matrix to the tape/fiber reinforcement.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a self-reinforced polymer composite.

FIG. 2 illustrates another self-reinforced polymer composite.

FIG. 3 illustrates a textile.

FIG. 4 illustrates a sheet of self-reinforced polymer.

FIG. 5 illustrates a sheet of self-reinforced polymer, an adhesive film, and a textile.

FIG. 6 illustrates an adhered stack of a sheet of self-reinforced polymer, an adhesive film, and a textile.

### DETAILED DESCRIPTION

Referring to FIG. 1, one manner of manufacturing the Self-Reinforced Polymer (“SRP”) composites includes hot compaction. Hot compaction is a method by which highly oriented polymer tapes are accurately heated. This heating allows approximately 10% of the polymer tapes to melt. With the application of pressure this molten polymer flows throughout the lattice work of tapes to form a continuous matrix. The sheet is then cooled while still under pressure to solidify the matrix. This process results in a rigid sheet which can then be thermoformed.

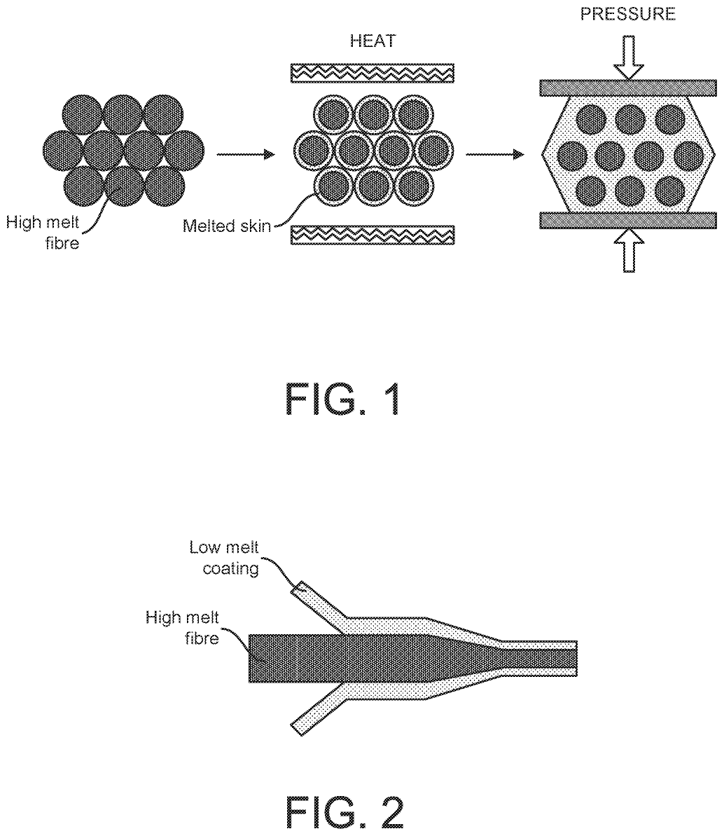

Referring to FIG. 2, another manner of manufacturing the SRP composites includes co-extrusion. Highly oriented polymer tapes are extruded from a high melting point grade of the chosen polymer. During this process, a low melting point grade of the same family of polymers is extruded on the surface of the tape. These tapes can then be woven to form a fabric. During post processing into shaped components the outer layer of the tapes melts before the inner core of oriented polymer. Under pressure this low melt grade flows throughout the fabric. On cooling this low melt grade of polymer re-solidifies to form the composite matrix.

Other techniques may be used to form SRP fabrics.

One type of preferred SRP material includes a woven thermoplastic composite material, of a tape yarn construction, that provides impact resistance and stiffness while having a light weight. Some types of self-reinforced composites and/or polymers may use other types of construction, including for example, crystal extrusions, and traditional thread. The woven thermoplastic composite material preferably includes a multi-layer construction, with an outer layer preferably having a melt point at a lower temperature than a core material sandwiched therein. The multiple layers of the fabric are stacked together and heat and pressure are applied to form a substantially rigid, impact resistant, material. For example, a homogenous glue may be coated on a fiber or tape, and then the fiber or tape is woven together, and then the layers of the fabric are composited through heat and pressure. Some types of the material, for example, may be constructed from a tape with a tensile modulus of 10 GPa or more, a shrinkage at 130 degrees C. of 6% or less, a sealing temperature of 120 degrees C. or more, and/or a denier of 900 or more. A single layer of the fabric preferably has a thickness of less than 1.0 mm. In general, self-reinforced polymeric materials (e.g., self-reinforced composite fabric) may be used, which may include one or more components, with the spatial alignment of the reinforcing phase in the matrix in 1D, 2D, or 3D.

By way of example, the woven thermoplastic composite material may start out a series of polypropylene (PP) films that form a tape yarn within a polymer matrix—for composite processing—before being woven into fabric. This is then pressed under heat and pressure to form a single piece approximately 0.005 inch (0.13 mm) that weighs just 0.02 lbs/sq.ft (0.11 kg/sq.m). Multiple layers are added depending on the desired thickness. The multi-layers are melted together. From there, the sheet can be formed into a variety of shapes using heat and pressure, depending on the mold. The end result contains no fragment-producing glass, unlike carbon fiber or various glass type structures has high impact resistance and retains strength from around +180 degrees F. down to −40 degrees F.

By way of example, the self-reinforced composite materials may include a density (kg/m3) of greater than 800, and more preferably greater than 900. By way of example, the self-reinforced composite materials may include a tensile modulus (GPa) between 3 and 35, and more preferably between 3 and 30. By way of example, the self-reinforced composite materials may include a tensile strength (MPa) of greater than 100, and more preferably greater than 125, and less than 500, and more preferably less than 400. By way of example, the self-reinforced composite materials may include a edgewise notched Izod impact strength at 20 degrees C. (J/m) of greater than 100 and less than 6000, and more preferably greater than 1250 and less than 5000. Also, hybrid SRC composite materials together with carbon or ultra-high molecular weight polyethylene (e.g., 3 to 8 million amu) may be used. By way of example, the UHMWPE powder grade GUR 4120 (molecular weight of approximately 5.0×106 g/mol) may be used to produce an isotropic part of the multilayered sample. The powder may be heated up to 180° C. at a pressure of 25 MPa in a stainless-steel mold to produce 80×10×2 mm3 rectangular samples, with fibers having an average diameter of 15 μm (e.g., 10-20 μm) and a linear density of 220 Dtex (e.g., 150-300 Dtex).

By way of example, Tegris thermoplastic composites (i.e., SRP) provide impact resistance and stiffness using three polymer layers in an ABA construction. The outer, or “A” layer melts at a lower temperature than the core “B” layer. To consolidate, multiple layers of fabric are stacked together and heat and pressure is applied to form a rigid, impact resistant material. For example, for the tape the tensile modulus is typically 14.0 GPa or more, the shrinkage (130 degrees C.) is less than 5.5%, the sealing temperature is 130 degrees C., and the denier is 1020 or more. For example, for the fabric the tensile has a peak load N of 720 or more, a peak load lbf of 160 or more, and an elongation at break (%) of 7.8 percent or less. The consolidated sheet typically has a bulk density of 0.78 or less, a thickness of 0.125 mm/layer, a tensile strength MPa of 200 or more, a modulus GPa of 5-6, an elongation at break % of 6 or more, and a flexural modulus GPA of 5-6.

The ability to join different components together is fundamental to the assembly of systems from multiple components. Unfortunately, it is known to be problematic to use adhesives to securely secure different SRP components together, especially due to the low surface free energy of the SRP component. This limitation is even more acute of an issue when attempting to securely adhere a fabric/textile to the SRP component.

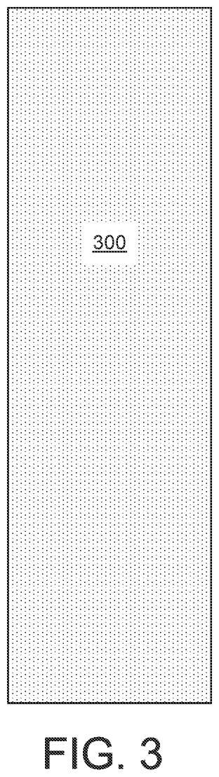

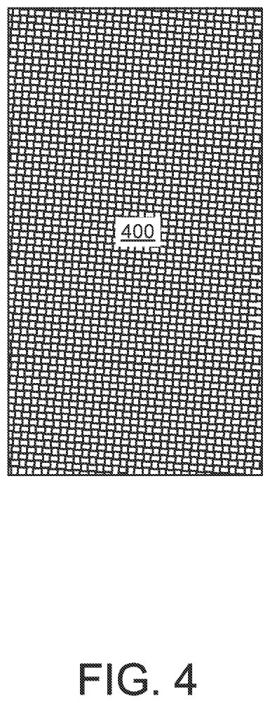

Referring to FIG. 3, to overcome the limitations of adhesives, fabric 300 may be secured to the SRP material 400 by sewing through the material stacked together with a strong thread around the perimeter of the SRP material and typically in a checkerboard pattern across the face of the material to maintain the fabric generally close to the SRP material in areas proximate the thread. Unfortunately, even with a relatively dense pattern of the checkerboard sewing pattern, the fabric material is not securely maintained in place across its face. When using one of hook and loop fabrics (e.g., Velcro®) secured to the SRP material (typically the loop), the other of the hook and loop is secured to a bag or other item (typically the hook), with the pair of fabrics being pressed together to form a connection. With the fabric only secured to the SRP material along the thread lines, the bag or other item will tend to sag and not be maintained in a secure location. Further, the thread tends to be heavy further weighing down the SRP material and fabric combination.

While a coating may be adhered to the SRP material, it is more preferable to directly adhere a fabric to the SRP material in a manner that provides a sufficiently strong bond. In general, it is desirable to adhere textiles to the SRP material, such as fabrics including woven and non-woven (films) fabrics, knit fabrics, veils, and/or scrims. By way of example, such textiles may be made from polyamide, polyester, polypropylene, polyethylene, Ultra HMWPE, etc.

With the surface energy of the SRP material being sufficiently low making it difficult to suitably adhere textiles to its surface, the surface of the SRP material may be optionally treated to increase its surface energy. The treatment may include a chemical treatment, which in addition to removing containments, increases the surface energy of the SRP material. An alcohol based product or a methyl ethyl ketone (C4H8O or CH3COCH2CH3) may be applied, such as using a roller, sponge, or cloth. The chemical treatment is then allowed a sufficient time to try prior to adhering a textile to its surface.

With the surface energy of the SRP material being sufficiently low making it difficult to suitably adhere textiles to its surface, the surface of the SRP material may be optionally treated to increase its surface energy. The treatment may further or alternatively include a corona treatment (e.g., air plasma) that receives a low temperature corona discharge plasma to impart changes in the properties of the surface. The corona treatment tends to increase the surface energy.

While the treatment of the surface of the SRP material tends to improve its ability to adhere to textiles, it is also desirable that the adhesive be in the form of a film, rather than a free flowing liquid, although a liquid may be used. The film tends to include an optimal matrix of adhesive that is flat, with predictable uniform characteristics, that may be trimmed to a suitable size. The film may include the same adhesive material on both sides, or have one type of adhesive on its first side and another type of adhesive on its second side. With different types of adhesives on each of the sides of the film, the film may be especially suitable for adhering to the SRP material on one side and especially suitable for adhering to the textile on its other side. By way of example, the film may be initially adhered to either the textile or the SRP material, then the combination of which is adhered to the other of the textile or the SRP material. Preferably, due to the temperature gradient between the SRP material (e.g., 230 degrees C.) and the fabric material (150 degrees C.), the film is adhered to the SRP material, and then the combination is adhered to the fabric. Alternatively, a sandwich structure may be formed and the stack of the SRP material, the film, and the textile may be adhered at the same time.

While the use of the surface treatment to the SRP material, if used, tends to improve the adherence characteristics of the SRP material, and the use of a film, if used, further tends to improve the adherence characteristics of the SRP material, the selection of the particular type of adhesive results in a sufficiently secure bond. Upon further reflection, it was determined that SRP materials are constructed from one of several different base materials, such as polyamide, polyethylene, UHMWPE, or polypropylene. To form a sufficiently strong adhesive bond to the SRP material, it was determined that the characteristics of the film should match that of the SRP material. For example, a polyamide based adhesive film should be used for SRP material having a polyamide base. For example, a polyethylene based adhesive film should be used for SRP material having a polyethylene base. For example, a polypropylene based adhesive film should be used for SRP material having a polypropylene base. Upon further reflection, it was determined that having similar chemical characteristics of the adhesive film and the SRP material results in a sufficiently strong bond.

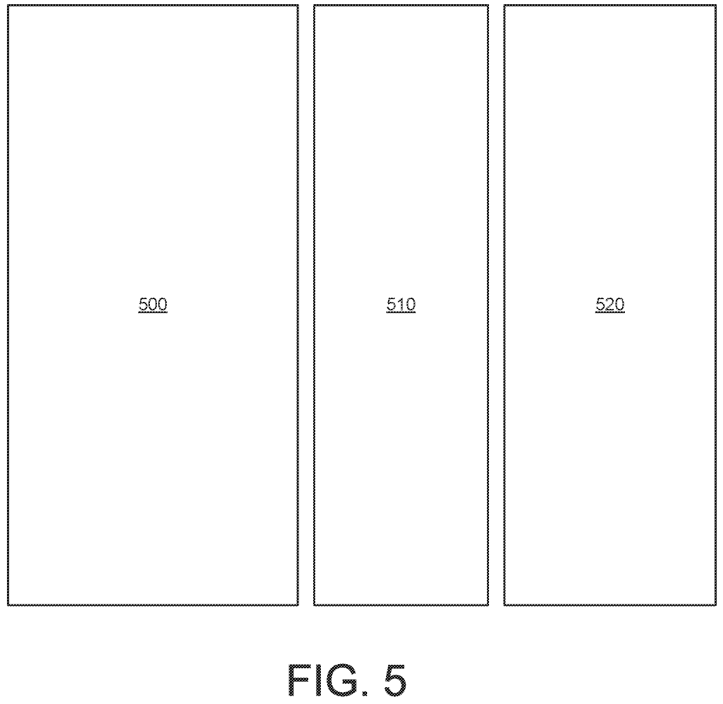

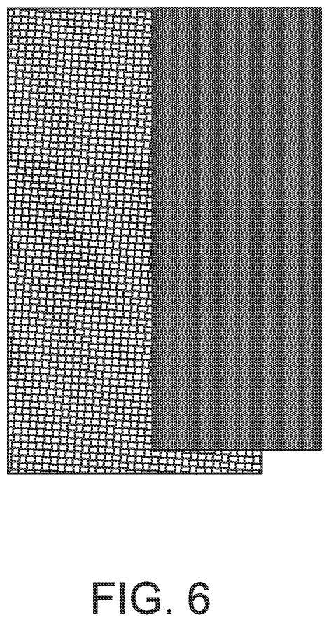

Referring to FIG. 5 and FIG. 6, a SRP material 500, a film 510, and a textile 520 are trimmed to an appropriate size, then the film 510 is used to adhere together the SRP material 500 to the textile 520, as illustrated in FIG. 6. As it may be observed, the textile is adhered to the SRP material across its entire surface, thereby maintaining a secure bond between the textile and the SRP material.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A self-reinforced composite material comprising:
(a) a layer of woven thermoplastic composite material;
(b) a plurality of layers of said woven thermoplastic layers;
(c) a textile material adhered to an exterior surface of said plurality of layers of said woven thermoplastic layers;
(d) a film adhesive material is included between said exterior surface of said plurality of layers of said woven thermoplastic layers and said textile material;
(e) where said woven thermoplastic layers is constructed from a base material selected from a group including polyamide, polyethylene, UHMWPE, and polypropylene;
(f) where said film adhesive is constructed from a base material selected from a group including polyamide, polyethylene, UHMWPE, and polypropylene;
(g) where said base material of said woven thermoplastic layers and said base layer of said film adhesive are the same.

2. The self-reinforced composite material of claim 1 wherein the exterior surface includes a chemical treatment prior to said textile material being adhered to said exterior surface of said plurality of layers of said woven thermoplastic layers.

3. The self-reinforced composite material of claim 1 wherein the exterior surface includes a corona discharge plasma treatment prior to said textile material being adhered to said exterior surface of said plurality of layers of said woven thermoplastic layers.
